(19) United States
(12) Patent Application Publication
(10) Pub. No.: US 2010/0251553 A1
(43) Pub. Date: Oct. 7, 2010

(54) CUTTING EDGE SYSTEM

(76) Inventor: Paul Kummer, Vancouver, WA (US)

Correspondence Address: RYLANDER & ASSOCIATES PC, 406 West 12th Street, Vancouver, WA, 98660, US

(21) Appl. No.: 12/753,878

(22) Filed: Apr. 3, 2010

Related U.S. Application Data
(60) Provisional application No. 61/166,317, filed on Apr. 3, 2009.

(51) Int. Cl. B26B 3/00; B26B 5/00; B26B 9/02

(52) U.S. Cl. 30/314; 30/165; 30/348; 30/356; 30/344

(57) ABSTRACT

A cutting edge system for cutting leather includes a replaceable beveled cutting edge with a stabilizing ridged side wall translating downward and forward pressure through hide slicing motions, a wrist accommodating set-off cutting edge holder which reduces movement of the cutting edge in relating to the holder, enhancing translation of downward pressure to forward hide slicing motion, biasing the knife point of balance from the edge to the holder, and a thumb configured control and guide support integral with said holder. A cutting edge system can further include first and second shank halves seating said cutting edge and forming a shank, first and second holder halves sandwiching said shank and said cutting edge, and one or more pins and one or more rivets securing said holder, shank, and cutting edge as one unit. A cutting edge system can further include a butt.

### CROSS-REFERENCE TO RELATED APPLICATION

This application claims the benefit of priority of co-pending provisional patent application Ser. No. 61/166,317 filed 3 Apr. 2009, which is incorporated herein by reference.

### FIELD OF THE INVENTION

The present invention relates to leather cutting tools. More particularly, the present invention relates to leather cutting edge systems.

### BACKGROUND

Leather hide cutting edges, knives and blades must be designed to address unique problems for the task, most caused by the great force and pressure required to cut through leather.

Currently, known cutting systems for cutting leather don't include replaceable blades: When a blade dulls or gets chipped it takes time to either sharpen the blade or send it to the manufacturer for grinding and sharpening. There is a need for a replaceable leather cutting blade so that the blade is easily replaceable so no production time need be lost.

Designing leather cutting knives with replaceable blades has been impeded due to the design constrained created by the requirement of withstanding the significant pressure put on the blade to enable the cutting of thick leather hides, which creates both downward and forward pressure. This pressure typically forces the blade to rock within the blade housing. There is a need for a replaceable blade with a solid seating arrangement eliminating or significantly reducing the possibility of blade movement within the handle.

Currently, when cutting leather the known knives are pushed and controlled or guided in part by the person's thumb. On the knives available the area for the thumb is narrow, being the width of the knife blade. With use the thumb becomes sensitive and sore. There is a need for a leather cutting edge which provides a wide base for thumb support which will aid in control and give personal comfort.

Known knife cutting system with ridged blade knives have the handle protruding from the blade at top dead center or 90 degrees from the back edge of the blade. In order to use the knife the wrist must be flexed or bent to start the cut at an exact point in the hide. There is a need for a head knife cutting system ergonomically designed to have the handle off set to accommodate the wrist, which also lessens the need for downward pressure so the operator can concentrate more on the forward motion and thus has greater control.

Known knife cutting systems for leather have straight sides or taper the full length of the blade which creates drag when cutting. There is a need for a cutting edge with a designed bevel which presents a thin cutting edge to the leather while maintaining a ridged side wall for overall stability and control.

With known knife cutting systems for leather, the point of balance of head knives is weight forward due to the blade which presents a safety concern if the knife should accidently fall. There is a need for a head knife cutting system with the point of balance is handle weighted so that if accidently falls it tends to fall safely.

Thus there is a need for a cutting edge system having the following features: (1) replaceable blade; (2) a cutting configuration with a solid seating arrangement to eliminate or reduce movement within the cutting edge handle; (3) wide thumb platform configured for control and guide knife motion; (4) cutting edge maximizing downward and forward force to forward hide slicing motion; (5) cutting edge and handle configuration set off from the cutting edge to accommodate the users wrist, lessening the need for downward pressure so the user can concentrate more on the forward motion and thus has greater control; (6) beveled cutting edge with a ridged side wall for stability and control; and, among others, (7) handle biased point of balance for safety.

The following represents a list of known related art:

| | | Date of |
|---|---|---|
| Reference: | Issued to: | Issue/Publication: |
| U.S. Pat. No. 80765 | Quackenbush | Aug. 4, 1868 |
| U.S. Pat. No. 893588 | Hughes | Jul. 14, 1908 |
| U.S. Pat. No. 436479 | Hise | Sep. 16, 1890 |

The teachings of each of the above-listed citations (which does not itself incorporate essential material by reference) are herein incorporated by reference. None of the above inventions and patents, taken either singularly or in combination, is seen to describe the instant invention as claimed.

Specifically, none of the existing known art is known to provide leather cutting edge system having features, including: (1) replaceable blade; (2) a cutting configuration with a solid seating arrangement to eliminate or reduce movement within the cutting edge handle; (3) wide thumb platform configured for control and guide knife motion; (4) cutting edge maximizing downward and forward force to forward hide slicing motion; (5) cutting edge and handle configuration set off from the cutting edge to accommodate the users wrist, lessening the need for downward pressure so the user can concentrate more on the forward motion and thus has greater control; (6) beveled cutting edge with a ridged side wall for stability and control; and, among others, (7) handle biased point of balance for safety.

### SUMMARY AND ADVANTAGES

A cutting edge system for cutting leather includes a replaceable beveled cutting edge with a stabilizing ridged side wall translating downward and forward pressure through hide slicing motions; a wrist accommodating set-off cutting edge holder to reduce movement of the replaceable beveled cutting edge in relating to the wrist accommodating set-off cutting edge holder, enhancing translation of downward pressure to forward hide slicing motion and biasing a cutting edge system point of balance from the replaceable beveled cutting edge to the wrist accommodating set-off cutting edge holder; and a thumb configured control and guide support integral with said wrist accommodating set-off cutting edge holder.

A cutting edge system of an embodiment can further include first and second shank halves to seat said replaceable beveled cutting edge and to form a shank; first and second holder halves to sandwich said shank and said replaceable beveled cutting edge; and one or more fasteners to substantially secure said first and second holder halves, shank, and replaceable beveled cutting edge as one unit. A cutting edge system of an embodiment can further include a holder butt to substantially surround at least a portion of said shank.

The cutting edge system of the present invention presents numerous advantages, including: (1) replaceable blade; (2) a cutting configuration with a solid seating arrangement to eliminate or reduce movement within the cutting edge handle; (3) wide thumb platform configured for control and guide knife motion; (4) cutting edge maximizing downward and forward force to forward hide slicing motion; (5) cutting edge and handle configuration set off from the cutting edge to accommodate the users wrist, lessening the need for downward pressure so the user can concentrate more on the forward motion and thus has greater control; (6) beveled cutting edge with a ridged side wall for stability and control; and, among others, (7) handle biased point of balance for safety.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a perspective view of a cutting edge system in use.

FIG. 2 shows a perspective view of a cutting edge system.

FIG. 3 shows an exploded view of a cutting edge system.

FIG. 4 shows a perspective view of another embodiment of a cutting edge system.

FIG. 5 shows an exploded view of another embodiment of a cutting edge system.

FIG. 6 is a top plan view of a blade portion of the cutting edge system of FIGS. 4 and 5.

FIG. 7 is an enlarged sectional view of the blade portion of FIG. 6, taken along the lines 7-7 thereof.

FIG. 8 is a top plan view of a shank half portion of the cutting edge system of FIGS. 4 and 5.

FIG. 9 is a sectional view of the shank half portion of FIG. 6, taken along the lines 9-9 thereof.

### REFERENCE NUMBERS USED IN DRAWINGS

Turning now descriptively to the drawings, in which similar reference characters denote similar elements throughout the several views, the figures illustrate a cutting edge system. With regard to the reference numerals used, the following numbering is used throughout the various drawing figures:
10 Cutting edge system
11 Blade
12 Cutting edge
13 Cutting edge aperture
14 Holder Shank
14a Holder Shank right half
14b Holder Shank left half
15 Shank apertures
16 Cutting edge holder
16a Holder right half
16b Holder left half
17 Holder apertures
18 Butt
19 Shank head aperture
20 Screw
22 Pins
24 Thumb configured control and guide support
25 Second thumb configured control and guide support
30 Another embodiment of a Cutting edge system
33 Cutting edge aperture
34 Holder Shank
34a Holder Shank right half
34b Holder Shank left half
35 Shank apertures
36 Cutting edge holder
36a Holder right half
36b Holder left half
37 Holder apertures
40 Screw
42 Pins
44 Thumb configured control and guide support
45 Second thumb configured control and guide support
H User
T Thumb
L Leather

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

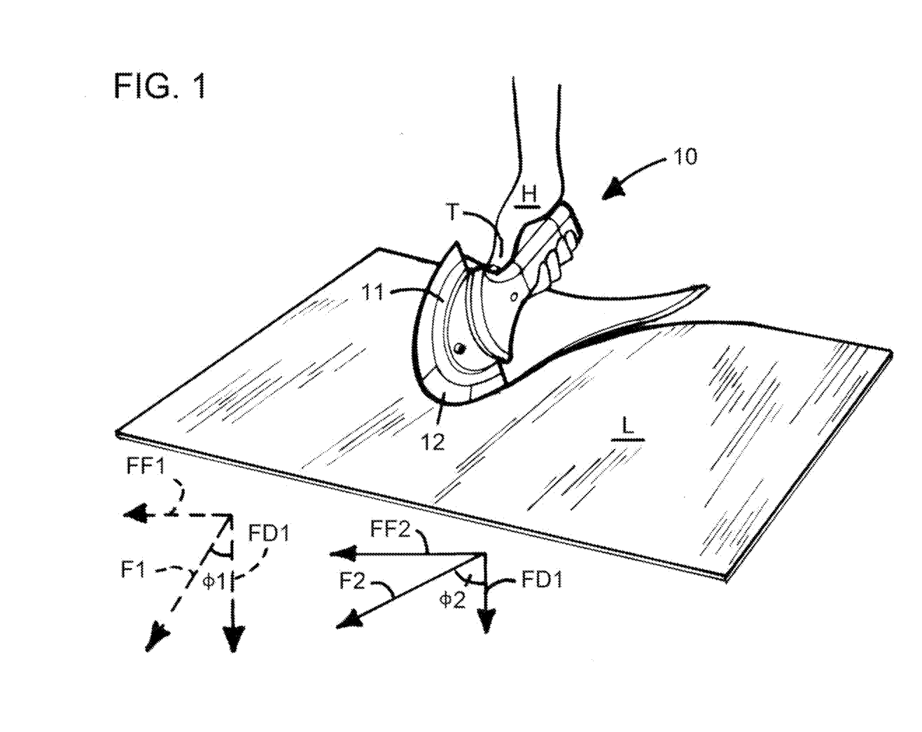

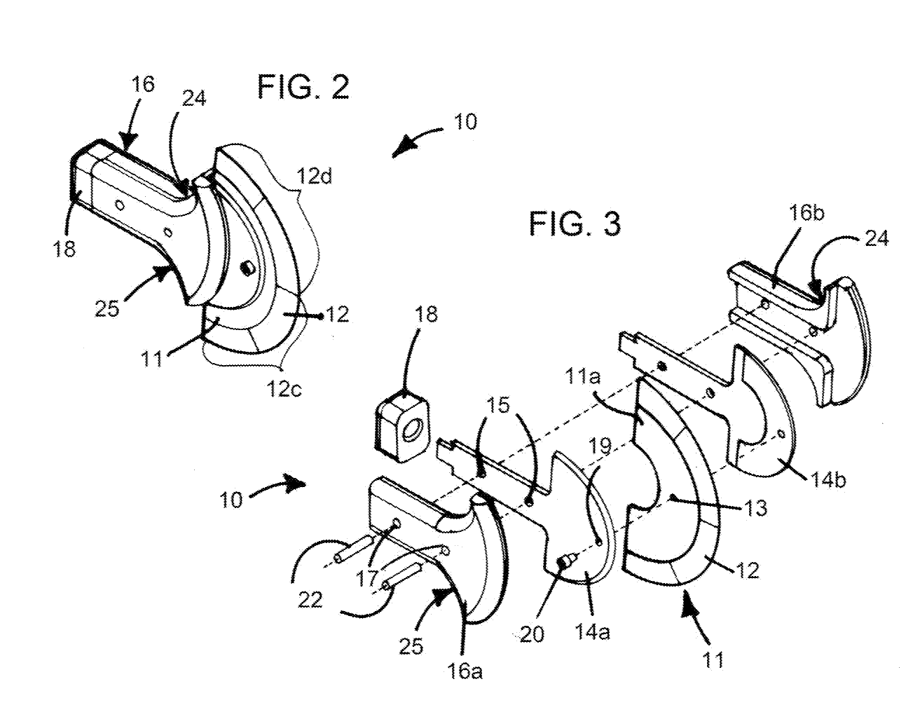

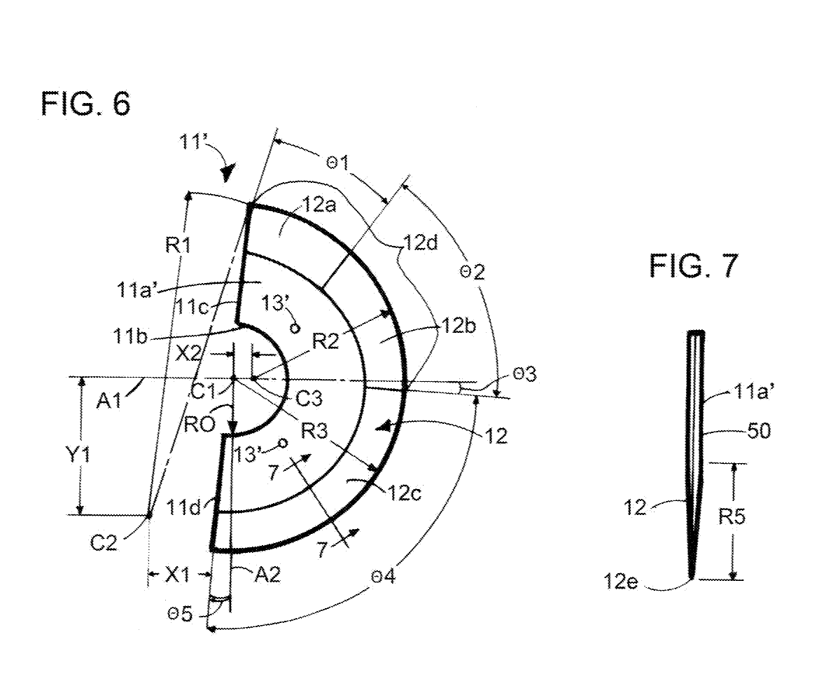

An overview of two embodiments of cutting edge systems will be described first with respect to FIGS. 1-5, followed by specifics relating to the components of these systems with further reference to the remaining FIGS. 6-9. As shown in FIGS. 1-3, a cutting edge system 10 is provided and comprises a replaceable blade 11 having a blade base 11a that supports an integral cutting blade edge 12. The blade base 11a comprises a stabilizing rigid sidewall that translates downward and forward pressure through hide the slicing motions described further below. The cutting edge system 10 includes a wrist accommodating, set-off or offset cutting edge holder 16 that holds blade 11. The holder 16 reduces movement of the cutting edge 12 in relation to the holder 16, enhancing translation of downward pressure applied by an operator's hand H into a forward hide slicing motion, and biasing the knife point of balance from the edge 12 to the holder 16. When assembled, a thumb configured control and guide support 24 is provided integral with the holder 16 to provide a comfortable resting place for an operator's thumb T while cutting leather L. The operator thumb T can then be used to guide the blade 11 to cut at a desired location.

In one embodiment, cutting edge 12 is provided with at least one cutting edge aperture 13 defined by the blade base 11a. The cutting edge system 10 may also include a mounting shank 14 comprising right and left holder shank halves 14a and 14b, each defining one or more shank apertures 15 therethrough. The cutting edge holder 16 comprises right and left holder halves 16a and 16b, each defining one or more holder apertures 17. In one embodiment, fasteners, such as rivet 20 and pins 22, secure the cutting edge 12, shank 14, and holder 16 together as one unit, with this substantially secure configuration forming the holder 16 with a pair of opposing thumb configured control and guide supports 24 and 25 each having a different radii to accommodate the offset orientation of blade 11 with respect to a handle portion of holder 16. Each shank half 14a and 14b also defines at least one blade holder aperture 19 aligned with a respective cutting edge aperture 13 when the cutting edge system 10 is assembled. In another embodiment, fasteners 20 and 22 may be removably attachable fasteners, such as screws with nuts or other internally threaded components. In an additional embodiment, fasteners 22 may be permanent fasteners to secure the holder 16 and shank 14 together as a unit, while fastener(s) 22 may be removable to facilitate replacement of blade 11 or removal of the blade 11 for sharpening.

In operation in one embodiment, user's hand H grasps the holder 16 of the cutting edge system 10 with user's thumb T placed on the thumb configured control and guide support 24. User exerts downward and forward pressure on the holder 16, while guiding the system 10 motion with the guide support 24 using the user's thumb T. The cutting edge system 10 translates this pressure and guide to correct forward motion slicing the leather hide L. The holder 16 secures the cutting edge 12 so that the cutting edge 12 does not move within the holder 16. If the user drops the cutting edge system 10 before, after, or during use, the holder biased point of balance biases the cutting edge system 10 to land handle first, instead of point first, saving the user from serious injury.

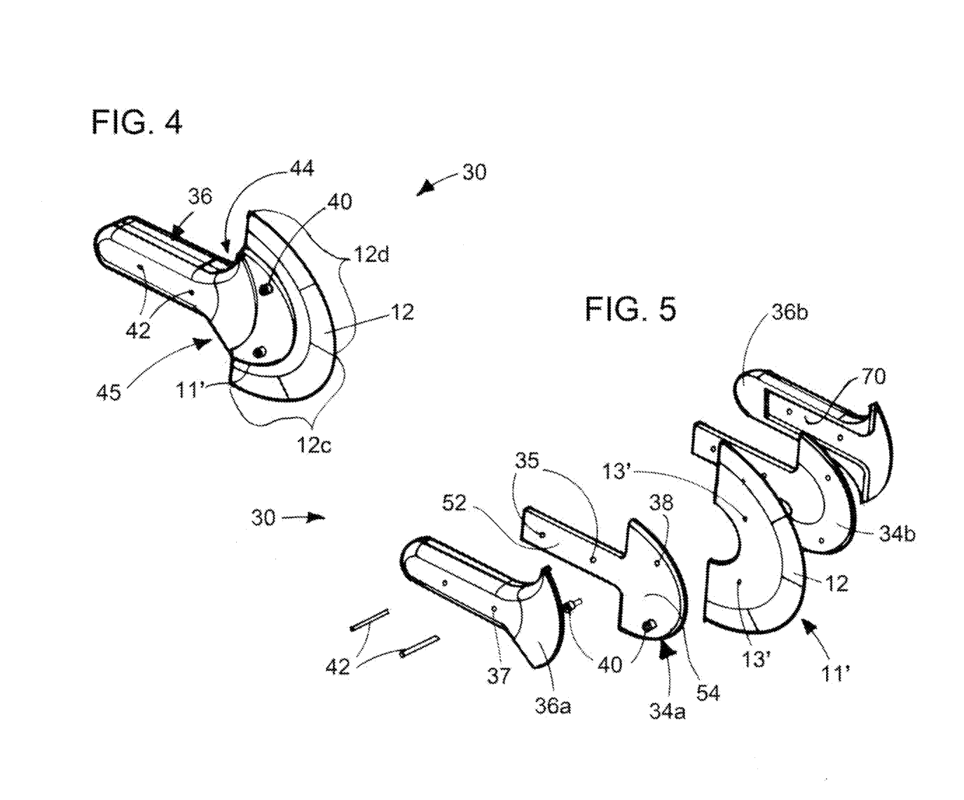

An alternative embodiment of a cutting edge system 30, shown in FIGS. 4 and 5 may include a cutting blade 11′ which may be constructed as described briefly above with respect to blade 11, and in greater detail below (FIGS. 6 and 7). Indeed, the main difference between blades 11 and 11′ of cutting edge systems 10 and 30, respectively, is the use of a single blade mounting aperture 13 for blade 11, and a pair of blade mounting apertures 13′ for blade 11′. Otherwise, the construction of blades 11 and 11′ may be substantially the same, as described with respect to FIGS. 6 and 7 below.

The cutting edge system 30 includes a shank 34 comprising right and left shank halves 34a and 34b, each defining one or more shank apertures 35 therethrough. Each of the shank halves 34a and 34b define one or more holder mounting apertures 35, here illustrated as a pair of apertures. The shank 34 may be seated in a cutting edge holder 36, for example, with the shank 34 sandwiched between the right and left holder halves 36a and 36b. The holder halves 36a and 36b may each define one or more holder apertures 37. The shank halves 34a and 34b each define one or more blade securing, mounting or holder apertures 38, here shown as a pair of apertures. The shank apertures 38 and the blade apertures 13′ are located to align together, and sized and/or configured to receive fasteners, such as removably attachable fastener screws 40 that may be removed to facilitate blade replacement or removal for sharpening. The holder apertures 37 and shank apertures 35 and shank apertures 38 are sized and/or configured to receive fasteners, for example as a pair permanently affixed pins 42 for securing together shank 34 and holder 36. Once secured together, the shank 34, holder 36 define first and second thumb configured control and guide supports 44 and 45, as shown in FIG. 4. Thumb supports 44 and 45 have different radii to provide a smooth transition from the blade 11′ to a handle portion of holder 36.

FIGS. 6 and 7 show blade 11′ as having base 11a′ defining an alignment surface comprising a semicircular, concave recessed alignment portion 11b adjoining and surrounded by a pair of alignment shoulder portions 11c and 11d. The alignment surfaces 11a, 11b, and 11c align blade 11′ with respect to a reference axis A1. The concave alignment portion 11b is centered about a reference center C1, located along reference axis A1, and may have a radius R0 (“R-Zero”), for example, on the order of 0.25-1.5 inches, or more particularly, ⅞ inch. Other shapes may be used to define the blade alignment surface, for example, the central portion 11b may be angular, and the shoulder portions 11c and 11d need not be coplanar.

The cutting edge 12 is shown here as a convex shape or contour, comprising a plurality of varying radius semicircular cutting edge portions 12a, 12b, and 12c, although other blade contours may be substituted in cutting edge systems 10 and 30. The first edge portion 12a has the radius R1 which is centered around a second centerpoint C2. The centerpoint C2 is offset from the reference axis A1 by a distance Y1. The centerpoint C2 is also offset from the reference center C1 by a distance X1 in a direction parallel to axis A1 and located outboard from blade 11′. For example, distance Y1 is approximately twice distance X1. Edge portion 12a extends circumferentially through a first arc Θ1 (“Theta 1”), which for example may be approximately at an angle of 10-30°, and more particularly about 18-20°, from the blade shoulder portion 11C.

The second edge portion 12b has a radius R2 which is centered around a third centerpoint C3. The centerpoint C3 may be offset from centerpoint C1 along the reference axis A1 by a distance X2 and an inboard direction from point C1 toward the blade 11′. For example, distance X2 is approximately ⅕ of distance X1. Edge portion 12b extends circumferentially through a second arc Θ2 (“Theta 2”), beginning around where the first arc Θ1 ends, such that there is a smooth transition between the first and second edge portions 12a and 12b. The second arc Θ2 may be at an angle of approximately 50-60°, and more particularly about 56°. Arc Θ2 extends to include and terminate at a third arcuate distance Θ3 (“Theta 3”) beyond the reference axis A1, which for example, may be at an angle of approximately up to 10°, and more particularly about 3°. Thus, together edge portions 12a and 12b form a flattened or multi-radius arc portion 12d of cutting edge 12.

The third edge portion 12c has a substantially circular contour having a radius centered around the reference centerpoint C1. Edge portion 12c extends circumferentially through a fourth arc Θ4 (“Theta 4”), beginning around where the third arc Θ3 ends, such that there is a smooth transition between the second and third edge portions 12b and 12c. The fourth arc Θ4 may beat an angle of approximately 80-100°, and more particularly about 91-94°, and even more particularly about 92°. Arc Θ4 extends to include and terminate at a fifth arcuate distance Θ5 (“Theta 5”) beyond a second reference axis A2, which is substantially perpendicular the reference axis A1. The arcuate length of arc Θ5 may be greater than arc Θ3, although other arcuate lengths may be selected for the fifth arc Θ5 to extend beyond axis A2, extending along for example, an angle of approximately up to 10°, and more particularly about 5°. Thus, the third edge portion 12c forms a substantially round side portion 12d of cutting edge 12.

FIG. 7 shows an enlarged edge view of blade 11′ including base 11a′ and cutting edge 12, which tapers to a contacting tip or cutting edge extremity 12e at the outer periphery of the convex blade 11′. With the changing radius of cutting edge extremity 12e from R1 to R2 to R3 along the flattened or multi-radius arc portion 12d, along with the transition to the round side portion 12d, the beveled the cutting edge 12 has a radial distance R5 which is best referenced as extending inwardly from the cutting edge extremity 12e. The beveled portion of cutting edge 12 extends a radial distance R5 which may be on the order of ¼ to one inch, and more particularly, ⅝ of an inch.

The earlier leather cutting devices typically had blades permanently attached to their handles, and often required return to the factory for sharpening which was a costly process both in terms of shipping and labor costs, as well as in work time lost. Moreover, in these earlier leather knives only the cutting edge was tempered, while the base of the blades remained untempered steel, which would not hold a cutting edge even if sharpened. Thus, these earlier knife blades could only be sharpened two or three times before the entire cutting knife, handle and all, had to be thrown away and replaced with a brand new knife. In contrast, blades 11 and 11′ are completely tempered from the cutting edge extremity 12e all the way back to the alignment surface 11a, 11b, and 11c. In this manner, blades 11 and 11′ may be sharpened many more times than earlier leather knives, down to where the holder 16, 36 interferes with the leather cutting operation.

Indeed, there are basically two leather cutting operations, one being a severing operation shown in FIG. 1 where blade 11 is substantially perpendicular to an exposed upper surface of the leather L. This severing operation is generally used to cut a smaller piece of leather away from a larger hide, and is typically referred to as “cutting” the leather by those skilled in the art. The other cutting operation is known in the art as “skiving” the leather. In the skiving operation, the blade 11 is rotated approximately 90° from the position of FIG. 1 around of the reference axis A1 so a flat side surface 50 (see FIG. 7) of the blade 11 is facing the exposed upper surface of leather L. The holder is then lowered toward the leather so cutting edge 12 is presented at an acute angle to the leather surface, allowing an operator to make a tapering or thinning cut by shaving off a horizontal slice of leather L through forward motion of cutting edge system 10 and 30.

In the cutting or severing operation of FIG. 1, the flattened or multi-radius arc portion 12d of serves as a cutting portion of blade 11 and 11′. In contrast, the rounded arc portion 12c of blade 11 and 11′ serves as a skiving portion of the blade 11 during the skiving operation. Thus, blade 11 and 11′ comprises a convex shaped cutting edge having a cutting portion adjacent a skiving portion, but they smooth transition therebetween. In one embodiment, the cutting portion has a substantially round configuration with a substantially uniform radius R3 centered about a first centerpoint, and the skiving portion comprises a multi-arcuate configuration comprising a plurality of adjoining arced sections 12a and 12b, each being non-concentric with the first centerpoint. In a further embodiment, each arced section of the skiving portion has a radius R1 and R2 different from one another and from the substantially uniform radius R3 of the cutting portion.

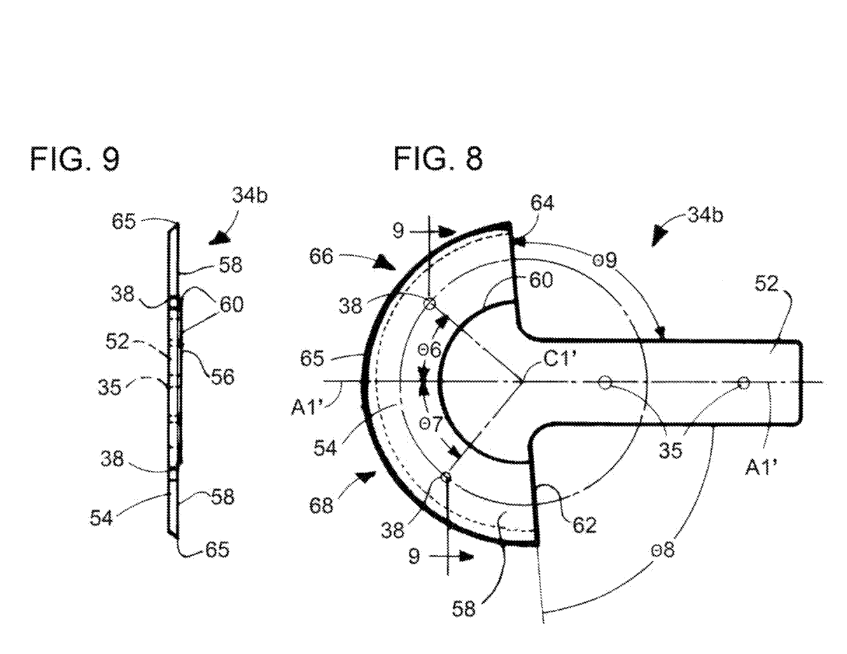

FIGS. 8 and 9 show shank half 34b, which is a mirror image of shank half 34a. Shank half 34a has a handle portion 52 that supports a head portion 54. The head portion 54 has a raised aligning land 56, which is raised with respect to a recessed mounting face 58, with an alignment portion 60 joining land 56 with mounting face 58. As shown in FIG. 5, the handle portion 52 is received by a recessed shank support 70 defined by holder 36b, and a similar recessed shank support (not shown) may be defined by holder 36a for receiving shank 34a. The handle portion 52 is aligned along a reference axis A1′ that is generally parallel to reference axis A1 of blade 11′ (see FIG. 6). The alignment portion 60 is shown as forming a convex alignment surface which has a generally perpendicular wall with respect to land 56 and mounting face 58. The convex alignment portion 60 has a radius R0′ centered about a centerpoint C1′, with radius R0′ and a centerpoint C1′ selected so the blade convex alignment surface 11b surrounds and receives the shank convex alignment portion 60. The head 54 also defines a pair of shoulder mounting portion 62 and 64 surrounding and extending outwardly from the convex alignment portion 60. The head 54 may terminate at an end distal from handle 52 in a convex periphery 65 having a generally semicircular circumference with a radius centered about centerpoint C1′ for convenience.

When blade 11′ is mounted to shank half 34b (for example, if FIGS. 6 and 8 are placed in face-to-face relationship aligning blade reference axis A1 with shank longitudinal axis A1' and aligning blade reference centerpoint C1 with shank head centerpoint C1′), blade apertures 13′ are aligned with shank head apertures 38. The shank head 54 has a severing portion 66 which is adjacent to the blade edge severing portion 12d, and a skiving portion 68 which is adjacent to the blade edge skiving portion 12c. In FIG. 8, the shank apertures 38 are located nonequal arcuate distances Θ6 (“Theta 6”) and 07 (“Theta 7”) from the longitudinal axis A1', with Θ6 being selected between selected between approximately 35° and 45°, and more particularly about 40°, and with Θ7 being selected between approximately 45° and 55°, and more particularly about 50°. FIG. 8 also illustrates the offset orientation of both head 54 and blade 11′ with respect to handle 52, which results in thumb support and guide surfaces 44 and 45 (see FIG. 4) having different radii. The different thumb support radii are illustrated as non-equal angles Θ8 (“Theta 8”) and Θ9 (“Theta 9”). In FIG. 8, arc Θ9 is greater than arc Θ8, and more particularly, arc Θ8 is less than 90° while arc Θ9 is greater than 90°. Even more particularly, the angle of Θ8 may be selected between 85° up to but not including 90°, such as approximately 85°, while the angle of Θ9 may be selected to be over 90° up to about 110°, such as approximately 95°. By having different radii for thumb supports 44 and 45, as well as for thumb supports 24 and 25, facilitates use of cutting-edge systems 10 and 30 for the severing operation with blade segment 12d, and for the skiving operation with blade segment 12c, because the edge cutting system 10, 30 has a different distinct feel when held by the operator's hand H when severing and when skiving. Indeed, after using cutting system 10, 30 for a period of time, an operator can grasp the handle portion of holder 16, 36 and without looking, the operator can tell whether the blade 11, 11′ is oriented for severing or skiving.

Thus, a replaceable leather cutting blade 11, 11′ is provided comprising a mounting base 11a, 11a′ having at least one alignment surface configured for receipt by a mounting portion of a holder 16, 36, and a beveled cutting edge 12 integral with the mounting base 11a, 11a′ and having a convex cutting edge extremity 12e, wherein both the mounting base 11a, 11a′ and cutting edge 12 are of a tempered steel which retains a cutting edge when sharpened. In one embodiment, the holder mounting portion may have a convex portion 60, with the blade alignment surface having a concave mounting portion 11b size to surround, contact, and receive the convex portion 60 of the holder mounting portion.

In a further embodiment, the blade holder comprises a shank 14, 34 defining at least one blade holder aperture 19, 38 therethrough, with the shank supporting the convex portion 60 of the holder mounting portion, and with the blade mounting base 11a, 11a′ defining at least one blade aperture 13, 13′ therethrough aligned with a respective blade holder aperture 19, 38, whereby a fastener removably secures the blade mounting base 11a, 11a′ to the shank 14, 34 when the blade alignment surface is received by the holder mounting portion. In another embodiment, the holder mounting portion further includes a pair of shoulder portions 62, 64 surrounding the convex portion 60, with the blade alignment surface having a pair of shoulder alignment portions 11c, 11d surrounding the concave mounting portion 11b each supported by a respective one of the pair of holder shoulder portions when the blade alignment surface is received by the holder mounting portion.

Referring back to FIG. 1, two vector force diagrams are shown, with the diagram dashed lines illustrated the forces experienced using earlier cutting systems, and the diagram and solid lines showing the improved forces experienced using cutting edge system 10 or 30. Referring first to the dashed line diagram, an applied force F1 is provided by operator's hand H using earlier cutting systems may be broken down into horizontal and vertical components FF1 and FD1, respectively. Force FD1 comprises a downward cutting force FD1 which severs the leather, while force FF1 comprises a forward motion force which advances blade 11 through the leather to continue the line of the cut. Note that due to the angle φ1 (“Phi one”) of the applied force F1, the downward force FD1 is much greater than the blade advancing forward force FF1.

In contrast, cutting edge systems 10 and 30 receive an applied force F2 (solid lined vector force diagram) provided by operator's hand H that has the same magnitude as force F1. The applied force F2 is resolved into a downward or cutting force component FD2, and a forward motion or advancing force complement FF2. Due to the construction of cutting edge systems 10 and 30, force F2 is applied at angle φ2 (“Phi two”), which is different than angle φ1, here illustrated as being a larger angle with respect to the vertical or downward component of force FD2. Comparing these two force diagrams, using cutting edge systems 10 and 30 the downward cutting force component FD2 required to sever the leather is less than component FD1 experienced using the earlier cutting systems. Furthermore, the advancing force component FF2 of cutting edge systems 10 and 30 is much greater than component FF1 of the earlier cutting systems, thereby facilitating faster cutting using cutting edge systems 10 and 30. Thus, cutting edge systems 10 and 30 allow an operator to apply less force to sever the leather L, reducing operator fatigue, while simultaneously promoting faster cutting than provided by earlier cutting systems.

Finally, referring back to FIGS. 1-3, use of the optional weighted butt portion 18 allows the holder portion 16 to rest securely in an operator's hand H. Furthermore, if an operator should drop cutting edge system 10, the weighted butt portion 18 tends to hit the floor first, protecting the cutting edge 12 from damage upon impact. In the alternative cutting edge system 30 of FIGS. 4-9, this handle weighting effect is provided by the handle portions 52 of shanks 34a and 34b. Indeed, in the illustrated embodiment the center of balance of the holder portion 36 is located in the vicinity of blade center point C1 to provide a very balanced feel to the operator using cutting edge system 30.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A cutting edge system, comprising:
a replaceable beveled cutting edge with a stabilizing ridged side wall translating downward and forward pressure through hide slicing motions;
a wrist accommodating set-off cutting edge holder to reduce movement of the replaceable beveled cutting edge in relating to the wrist accommodating set-off cutting edge holder, enhancing translation of downward pressure to forward hide slicing motion and biasing a cutting edge system point of balance from the replaceable beveled cutting edge to the wrist accommodating set-off cutting edge holder; and
a thumb configured control and guide support integral with said wrist accommodating set-off cutting edge holder.

2. The cutting edge system of claim 1, further comprising:
first and second shank halves to seat said replaceable beveled cutting edge and to form a shank;
first and second holder halves to sandwich said shank and said replaceable beveled cutting edge; and
one or more fasteners to substantially secure said first and second holder halves, shank, and replaceable beveled cutting edge as one unit.

3. The cutting edge system of claim 2, further comprising a holder butt to substantially surround at least a portion of said shank.

4. The cutting edge system of claim 3, wherein the cutting edge system includes a center of gravity that shifts away from the replaceable beveled cutting edge when the replaceable beveled cutting edge is sandwiched between the first and second shank halves and is assembled with said holder butt.

5. A replacement cutting blade for receipt by a holder having a mounting portion, comprising:
a mounting base including at least one blade alignment surface configured for receipt by the holder mounting portion; and
a beveled cutting edge integral with the mounting base and including a convex cutting edge extremity;
wherein both the mounting base and beveled cutting edge further include a tempered steel having edge-retaining properties.

6. The replacement cutting blade of claim 5 wherein the holder mounting portion further comprises a convex mounting portion and the blade alignment surface further includes a concave mounting portion configured to substantially surround, contact, and receive the holder convex mounting portion.

7. The replacement cutting blade of claim 6 wherein the holder mounting portion further comprises a pair of shoulder mounting portions to substantially surround the convex mounting portion, and the blade alignment surface further includes a pair of shoulder alignment portions to substantially surround the concave mounting portion, each shoulder alignment portion further configured to align with a respective one of the shoulder mounting portions when the blade alignment surface receives the holder mounting portion.

8. The replacement cutting blade of claim 6 wherein the holder further comprises:
a shank to support the holder convex mounting portion, wherein the shank defines at least one blade holder aperture therethrough, and wherein the blade mounting base defines at least one blade aperture therethrough; and
at least one fastener to removably secure the blade mounting base to the shank when the blade alignment surface receives the holder mounting portion.

9. The replacement cutting blade of claim 5 wherein the convex cutting edge extremity comprises:
a first cutting portion having a substantially semicircular configuration centered about a first centerpoint; and
a skiving cutting portion adjoining said first cutting portion, said skiving cutting portion including a plurality of adjoining arced sections nonconcentric with the first centerpoint.

10. The replacement cutting blade of claim 5 wherein the convex cutting edge extremity comprises:
a first cutting portion having a substantially semicircular configuration having a first radius; and
a skiving cutting portion adjoining said first cutting portion, said skiving cutting portion including a plurality of adjoining arced sections having non-equal radii different from said first radius.

11. The replacement cutting blade of claim 10 wherein:
the first cutting portion is substantially centered about a first centerpoint; and
each of the arced sections of the skiving cutting portion originates from a second centerpoint that is nonconcentric with the first centerpoint.

12. A cutting edge system held by an operator's hand during a cutting operation, comprising:
a holder having a handle portion and a head mounting portion;
a blade having a blade base supporting a cutting edge with a convex cutting extremity distal from said blade base; and
one or more fastener members to removably attach the blade base to the holder head mounting portion;
wherein the holder further includes a thumb support to support a thumb of the operator's hand during the cutting operation.

13. The cutting edge system of claim 12, wherein the holder comprises a pair of mating halves that sandwich the blade base therebetween.

14. The cutting edge system of claim 12, further comprising a shank including a shank handle portion received within the holder handle portion, the shank further including a shank head portion to serve as the holder head mounting portion.

15. The cutting edge system of claim 12, wherein the thumb support comprises a portion of the blade base.

16. The cutting edge system of claim 12, wherein said cutting operation further comprises a first cutting operation and a skiving operation, and wherein:
the convex cutting extremity includes:
a first cutting portion having a substantially semicircular configuration defining a first arc to cut during said first cutting operation; and
a skiving cutting portion adjoining said first cutting portion, said skiving cutting portion including a plurality of adjoining arced sections each defining an arc different from said first arc, said skiving cutting portion performing said skiving operation;
the thumb support includes:
a first thumb support located on the holder to support the thumb during said first cutting operation; and
a skiving thumb support located on the holder to support the thumb during said skiving operation.

17. The cutting edge system of claim 16, wherein:
said first thumb support has a first concave thumb support surface having a first radius; and
said skiving thumb support has a second concave thumb support surface having a second radius different from said first radius.

18. The cutting edge system of claim 12, wherein:
the holder handle portion defines a longitudinal axis;
the holder head mounting portion is substantially semi-circular having a radius extending from a centerpoint located on the longitudinal axis, the head mounting portion being offset from and nonsymmetrical with respect to the longitudinal axis; and
the blade is nonsymmetrical with respect to the longitudinal axis.

19. The cutting edge system of claim 12, wherein the blade comprises an integral unit including the blade base and cutting edge, and wherein the blade includes a tempered steel having edge-retaining properties.

20. The cutting edge system of claim 12, wherein:
the holder head mounting portion comprises a convex mounting surface; and
the blade base comprises a concave alignment surface configured to substantially surround, contact, and receive said convex mounting surface of the holder head mounting portion.
